(19) United States
(12) Patent Application Publication
(10) Pub. No.: US 2016/0045974 A1
(43) Pub. Date: Feb. 18, 2016

(54) OPEN-PIPE WELD SHIELDING SYSTEM FOR ELECTRIC RESISTANCE WELDED STEEL PIPE OR TUBE

(71) Applicant: JFE STEEL CORPORATION, Tokyo (JP)

(72) Inventors: Takatoshi OKABE, Tokyo (JP); Masatoshi ARATANI, Tokyo (JP); Shunsuke TOYODA, Tokyo (JP); Sota GOTO, Tokyo (JP); Hideto KIMURA, Tokyo (JP)

(73) Assignee: JFE STEEL CORPORATION, Tokyo (JP)

(21) Appl. No.: 14/780,147

(22) PCT Filed: Mar. 18, 2014
(86) PCT No.: PCT/JP2014/001549

§ 371 Date: Sep. 25, 2015

(30) Foreign Application Priority Data
Mar. 25, 2013 (JP) 2013-061275

(51) Int. Cl. B23K 11/00; B23K 11/087; B23K 35/38

(52) U.S. Cl. CPC B23K 11/0006; B23K 35/383; B23K 11/0873

(57) ABSTRACT

An open-pipe weld shielding arrangement for an electric resistance welded steel pipe or tube includes a shielding-gas blowing nozzle and a gas flow rate controller. The shielding-gas blowing nozzle includes a gas outlet disposed at a position 5 to 300 mm above upper ends of portions to be welded, and the gas flow rate controller controls the flow rate of the shielding gas blown from the gas outlet to 0.5 to 50 m/sec.

### TECHNICAL FIELD

This application is directed to open-pipe weld shielding arrangements for electric resistance welded steel pipes or tubes, and particularly relates to an open-pipe weld shielding arrangement for electric resistance welded steel pipes or tubes that is suitable for the manufacture of electric resistance welded steel pipes or tubes requiring welds with good mechanical characteristics, including oil country tubular goods, line pipes, and automotive parts.

### BACKGROUND

Steel pipes or tubes are typically divided into welded steel pipes or tubes and seamless steel pipes or tubes. Welded steel pipes or tubes, such as electric resistance welded steel pipes or tubes, are manufactured by rounding steel sheets (hereinafter referred to as “steel strips”) and butt welding ends thereof. Seamless steel pipes or tubes are manufactured by piercing billets at high temperature and rolling them in machines such as mandrel mills. Welded steel pipes or tubes are generally thought to have poorer characteristics in the weld than in the base metal. There has been controversy over how to ensure good weld characteristics, such as high toughness, strength, and elongation, of welded steel pipes or tubes depending on the application.

For example, pipe strength is regarded as important for line pipes for transportation of materials such as crude oil and natural gas since they are often installed in cold regions, where high low-temperature toughness is required.

To ensure good characteristics such as high strength, the alloy design of hot-rolled steel sheets, which form the base metal of steel pipes or tubes, is typically determined depending on the characteristics of the base metal of finished steel pipes or tubes.

However, the development of welding technology is important since the weld characteristics depend more heavily on the electric resistance welding process than on the factors such as the alloy design of the base metal and the heat treatment. Poor electric resistance welding often results from penetrators, which are oxide-based welding defects that occur and remain between the welded portions (i.e., butting edges of an open pipe (as rolled steel strip), which is formed by rounding a steel strip such that the two end surfaces thereof in the circumferential direction abut each other) after electric resistance welding. These residual penetrators result in low toughness and insufficient strength.

Accordingly, numerous gas shield welding methods and apparatuses have been proposed in the related art to prevent oxidation of the portions to be welded by gas blowing over the portions to be welded and thereby to avoid penetrators, which are responsible for poor electric resistance welding, from the portions to be welded.

For example, Patent Literature 1 discloses a weld shielding arrangement for electric resistance welded pipes or tubes that includes a shield cover attached to a roll stand for squeeze rolls. The shield cover covers a welding machine and an open pipe only around the portions to be welded to minimize the enclosed space around the portions to be welded. This allows for a rapid reduction in the oxygen concentration around the portions to be welded.

Patent Literature 2 discloses a system that supplies a liquefied inert gas from liquefied gas piping to an impeder case inserted into an open pipe to cool an impeder core and then ejects the liquefied gas toward the welding point to perform gas shielding.

Patent Literature 3 discloses a system that supplies a gas at a given flow rate from a gas supply line to a shield box covering the entire open pipe in the region extending from the heating starting point to the welding point at the edges of the open pipe as well as an induction coil for edge heating and squeeze rolls.

### CITATION LIST

### Patent Literature

[PTL 1] Japanese Unexamined Patent Application Publication No. 8-300164

[PTL 2] Japanese Unexamined Patent Application Publication No. 10-249547

[PTL 3] Japanese Unexamined Patent Application Publication No. 2011-206813

### SUMMARY

### Technical Problem

The conventional methods for gas shielding, by gas blowing only around the welding point from outside (Patent Literature 1) or inside (Patent Literature 2), may result in oxides remaining in the weld due to insufficient shielding.

The conventional system that includes where the shield box covers the entire open pipe in the region extending from the heating starting point to the welding point at the edges of the open pipe (Patent Literature 3) is complicated and time-consuming to assemble and also requires the replacement and adjustment of the shield box for different pipe sizes. This system is therefore disadvantageous in terms of efficiency and pipe-making cost.

As discussed above, there is a problem with the related art in that the oxygen concentration around the portions to be welded during electric resistance welding cannot be sufficiently reduced by reliable gas shielding of the portions to be welded, and therefore penetrators cannot be avoided, without sacrificing pipe-making cost and efficiency.

### Solution to Problem

The inventors have conducted extensive research to solve the foregoing problem. As a result, the inventors have made the following findings, which have led to the disclosed embodiments. In embodiments, a shielding gas is blown over the portions to be welded of an open pipe from immediately above the portions to be welded in the region extending from the heating starting point to the welding point at the edges of the open pipe. The gas is blown without a shield box covering the entire open pipe in the region extending from the heating starting point to the welding point at the edges of the open pipe. During the gas blowing, the oxygen concentration around the portions to be welded can be sufficiently reduced by properly controlling the nozzle height, i.e., the height from the upper end of the portions to be welded to a shielding-gas injection hole in a shielding-gas blowing nozzle, as well as the shielding gas flow rate. This disclosure provides:

(1) An open-pipe weld shielding arrangement and system for an electric resistance welded steel pipe or tube is configured for use in the manufacture of an electric resistance welded steel pipe or tube to shield portions to be welded with a shielding gas composed of an inert gas by blowing the shielding gas from above the portions to be welded during electric resistance welding. The shielding arrangement includes a shielding-gas blowing nozzle including a gas outlet disposed at a position 5 to 300 mm above upper ends of the portions to be welded and gas flow rate control means for controlling the flow rate of the shielding gas blown from the gas outlet to 0.5 to 50 m/sec.

(2) In the open-pipe weld shielding arrangement for an electric resistance welded steel pipe or tube according to Item (1), the gas outlet is rectangular and has a length of 30 mm or more in a feed direction and a width R of 5 mm or more in a butt welding direction of the open pipe.

(3) In the open-pipe weld shielding arrangement for an electric resistance welded steel pipe or tube according to Item (1) or (2), the gas outlet satisfies the relationship R/W>1.0, where R is the width of the gas outlet in the butt welding direction of the open pipe, and W is the maximum distance between end surfaces of the portions to be welded immediately below the gas outlet.

(4) In the open-pipe weld shielding arrangement for an electric resistance welded steel pipe or tube according to Item (1) or (2), the inert gas is replaced by a gas containing 0.1% by volume or more reducing gas.

(5) In the weld shielding arrangement for an electric resistance welded steel pipe or tube according to Item (3), the inert gas is replaced by a gas containing 0.1% by volume or more reducing gas.

### Advantageous Effects

The open-pipe weld shielding arrangement for an electric resistance welded steel pipe or tube, according to embodiments, can maintain a sufficiently low oxygen concentration around the portions to be welded during electric resistance welding. This reliably improves the weld characteristics of the electric resistance welded steel pipe or tube compared to existing electric resistance welded steel pipes or tubes.

### BRIEF DESCRIPTION OF THE DRAWINGS

FIG. 1(a) is a schematic view illustrating a process of manufacturing an electric resistance welded steel pipe or tube according to embodiments;

FIG. 1(b) is a sectional view of a shielding-gas blowing nozzle and the area A of the electric resistance welded steel pipe or tube according to embodiments;

FIG. 1(c) is a schematic view illustrating a flow of shielding gas at low flow rate according to embodiments;

FIG. 1(d) is a schematic view illustrating a flow of shielding gas at proper flow rate according to embodiments;

FIG. 1(e) is a schematic view illustrating a flow of shielding gas at high flow rate according to embodiments;

FIG. 2 is a graph showing the relationship between the flow rate of the shielding gas and the oxygen concentration around the portions to be welded (butting edges of an open pipe); and

FIG. 3 is a schematic view of an open-pipe weld shielding arrangement for an electric resistance welded steel pipe or tube according to embodiments.

### DETAILED DESCRIPTION

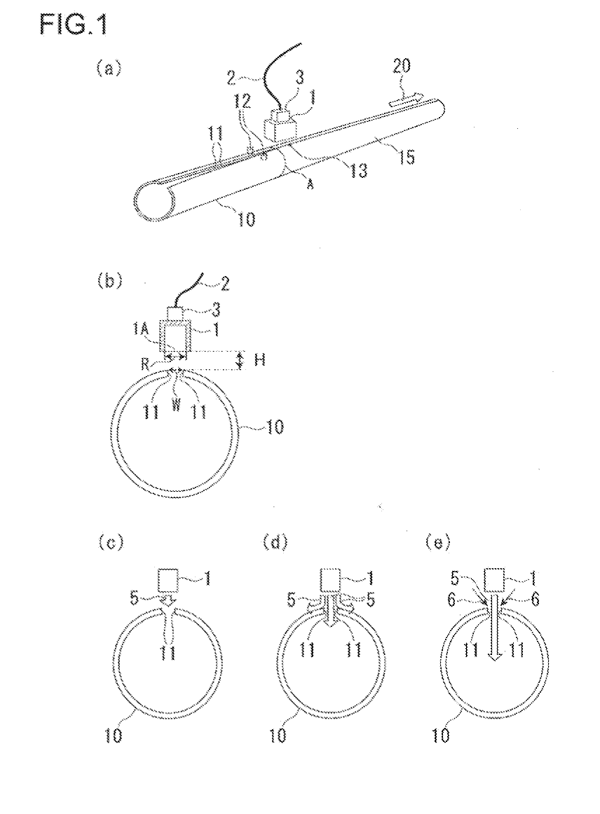

FIG. 1 is a set of schematic views illustrating a steel strip that is continuously fed from an uncoiler (not shown) and that is leveled by a leveler (not shown). While the steel strip is being advanced in the feed direction (also referred to as “forming direction”) 20, the strip is rounded along the width into an open pipe 10 by a roll former (not shown) such that the two end surfaces of the open pipe (corresponding to the two end surfaces of the strip that has yet to be rounded along the width) abut each other. The portions 11 to be welded of the open pipe (butting edges of the open pipe) are welded together by an electric sewing welding machine (including a power supply device for edge heating (not shown) and squeeze rolls for pressure welding (not shown)) to form an electric resistance welded steel pipe or tube 15. Reference numeral 12 denotes the heating starting point at the edges of the open pipe. Reference numeral 13 denotes the welding point where the portions 11 to be welded are welded together by pressure welding in the feed direction. An impeder (not shown) may be disposed inside the open pipe 10 or the electric resistance welded steel pipe or tube 15. After the electric resistance welded steel pipe or tube 15 leaves the electric sewing welding machine, the outer diameter thereof is adjusted by a sizer (not shown).

In disclosed embodiments, a shielding range is defined in the entire region extending from the heating starting point 12 to the welding point 13 at the edges of the open pipe in the feed direction or in a zone within that region where oxides tend to occur between the welded portions (this zone can be located by preliminary investigation). A shielding-gas blowing nozzle (abbreviated as “nozzle”) 1 is disposed in the shielding range immediately above the portions 11 to be welded. A gas tube 2 is connected to the nozzle 1 via a gas flow rate controller 3. A shielding gas supplied from the gas tube is blown from the nozzle 1 over the portions 11 to be welded at a proper flow rate controlled by the gas flow rate controller 3.

The nozzle 1 is disposed such that a gas outlet 1A faces the upper ends of the portions 11 to be welded.

The inventors have examined in detail the flow of the shielding gas. The inventors have also researched in detail the influence of various shielding gas blowing conditions, such as the position and size of the gas outlet 1A and the flow rate of the shielding gas through the gas outlet 1A, on the oxygen concentration around the portions 11 to be welded during electric resistance welding and the oxide area percentage of the electric resistance weld formed between the welded portions.

As a result, the inventors have found that, under the optimum shielding gas blowing conditions, the oxygen concentration around the portions to be welded is 0.01% by volume or less, and the oxide area percentage of the weld is 0.1% or less. As used herein, the oxide area percentage of the weld is defined as follows: A fracture surface formed by subjecting an electric resistance weld to a Charpy impact test is observed in at least ten fields of view under an electron microscope at a magnification of 500 times or more. The total area of oxide-containing dimple fracture surface areas found in the fracture surface is measured. The oxide area percentage is calculated as the percentage of the total area of the oxides relative to the total area of the fields of view.

The optimum conditions determined by the inventors are as follows: the nozzle height H, i.e., the height from the upper ends of the portions 11 to be welded to the gas outlet 1A, is 5 to 300 mm (see FIG. 1(b)), and the flow rate of the shielding gas 5 through the gas outlet 1A (hereinafter also referred to as “gas outlet flow rate”) is 0.5 to 50 m/sec. (see FIG. 1(d)).

If the nozzle height exceeds 300 mm, an insufficient amount of shielding gas reaches the portions 11 to be welded. Thus, an oxygen concentration of 0.01% by volume or less around the portions 11 to be welded is not achieved. A lower nozzle height is desirable. If the nozzle height falls below 5 mm, however, the gas outlet 1A is readily damaged by radiation heat from the portions 11 to be welded under heating, and spatter produced from the portions 11 to be welded collides with the nozzle 1 and thus degrades the durability of the nozzle 1.

If the shielding gas 5 flows through the gas outlet 1A at an insufficient flow rate, the shielding gas 5 spreads out and insufficiently shields the portions 11 to be welded (see FIG. 1(c)). If the shielding gas 5 flows through the gas outlet 1A at an excessive flow rate, the shielding gas 5 blows intensely and causes air entrainment 6 between the end surfaces of the portions 11 to be welded (see FIG. 1(e)). If the shielding gas 5 flows through the gas outlet 1A at a proper flow rate (0.5 to 50 m/sec.), the shielding gas 5 sufficiently, but not excessively, fills the gap between the end surfaces of the portions 11 to be welded without causing air entrainment, thus allowing sufficient gas shielding (see FIG. 1(d)).

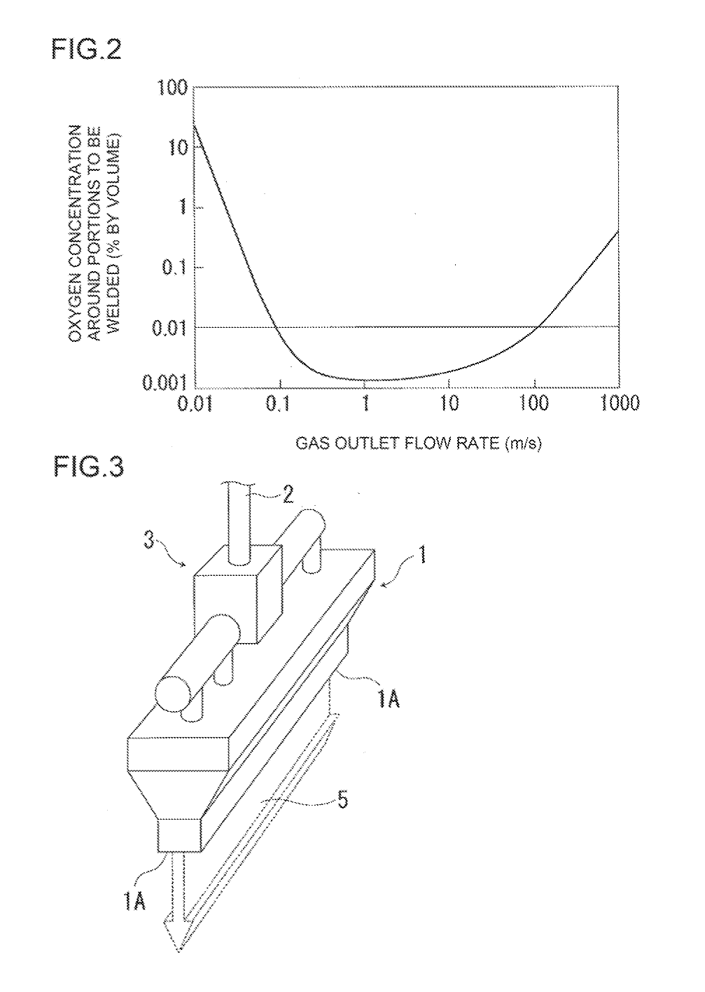

FIG. 2 is a graph showing example measurements of the oxygen concentration at the middle position between the end surfaces of the portions 11 to be welded. The shielding gas 5 was blown over the portions 11 to be welded at a nozzle height H of 50 mm and varying gas outlet flow rates. These measurements show that an oxygen concentration of 0.01% by volume or less around the portions to be welded can be reliably achieved by controlling the gas outlet flow rate to 0.5 to 50 m/sec.

The gas outlet 1A is preferably rectangular and has a length of 30 mm or more in the feed direction 20 and a width R of 5 mm or more in the butt welding direction of the open pipe. Such a shape contributes to more uniform gas blowing over the portions 11 to be welded.

The gas outlet 1A preferably satisfies R/W>1.0, where, as shown in FIG. 1(b), R is the width of the gas outlet 1A in the butt welding direction of the open pipe, and W is the maximum distance between the end surfaces of the portions 11 to be welded immediately below the gas outlet 1A. This allows for a more rapid reduction in the oxygen concentration around the portions 11 to be welded. More preferably, the gas outlet 1A satisfies 1.5<R/W<25.

The shielding gas used is an inert gas. As used herein, the term “inert gas” refers to gases such as nitrogen gas, helium gas, argon gas, neon gas, xenon gas, and mixtures thereof. The inert gas preferably has a purity of 99.9% or more.

The inert gas used as the shielding gas may be replaced by a gas containing 0.1% by volume or more reducing gas. A gas containing 0.1% by volume or more reducing gas is preferred since it is more effective in reducing the formation of oxides, which are responsible for penetrators, and thus in improving the toughness or strength of the weld. As used herein, the term “reducing gas” refers to gases such as hydrogen gas, carbon monoxide gas, methane gas, propane gas, and mixtures thereof. The gas containing 0.1% by volume or more reducing gas is preferably a reducing gas alone or a gas containing 0.1% by volume or more reducing gas and the balance an inert gas.

The following shielding gases are preferred for their availability and low cost:

(a) If inert gases are used alone, (A) nitrogen gas, helium gas, argon gas, and mixtures thereof are preferred. A particularly preferred combination of inert gases is a mixture of nitrogen gas and argon gas.

(b) If reducing gases are used alone, (B) hydrogen gas, carbon monoxide gas, and mixtures thereof are preferred.

(c) If mixtures of inert gases and reducing gases are used, mixtures of the gases (A) and (B) are preferred. A particularly preferred mixture of gases is a mixture of nitrogen gas and hydrogen gas.

It should be understood that careful safety measures should be taken if gases containing hydrogen gas and/or carbon monoxide gas are used.

### Example 1

Electric resistance welded steel pipes or tubes made of a low-carbon low-alloy steel and having an outer diameter of 600 mm and a wall thickness of 20.6 mm were manufactured by passing steel strips through a pipe-making system including, in sequence, an uncoiler, a leveler, a roll former, an electric sewing welding machine, and a sizer. During electric resistance welding, the portions to be welded were shielded with a shielding gas using an open-pipe weld shielding arrangement for electric resistance welded steel pipes or tubes shown in FIG. 3. The oxygen concentration around the portions to be welded and the oxide area percentage of the weld were measured under the various gas blowing conditions shown in Table 1. The groove was straight. The shielding gas was nitrogen gas. The reducing gas was hydrogen gas. The gas outlet was rectangular. The results are shown in Table 1.

As shown in Table 1, the oxygen concentrations around the portions to be welded and the oxide area percentages of the welds of the inventive examples were significantly lower than those of the comparative examples.

TABLE 1

| | | | | | Oxygen concentration | Oxide area | |
|---|---|---|---|---|---|---|---|
| | Nozzle | Gas outlet | | Reducing gas | around portions to be | percentage | |
| | height | flow rate | | content | welded | of weld | |
| No. | (mm) | (m/sec.) | R/W | (% by volume) | (% by volume × 10²) | (%) | Remarks |
| 1 | 100 | 0.5 | 5 | None | 0.2 | 0.03 | Inventive example |
| 2 | 100 | 1.0 | 5 | None | 0.5 | 0.03 | Inventive example |
| 3 | 100 | 5 | 5 | None | 0.2 | 0.02 | Inventive example |
| 4 | 100 | 10 | 5 | None | 0.1 | <0.01 | Inventive example |
| 5 | 100 | 50 | 5 | None | 0.1 | 0.02 | Inventive example |
| 6 | 200 | 0.5 | 5 | None | 0.8 | 0.03 | Inventive example |
| 7 | 200 | 1.0 | 5 | None | 0.8 | 0.03 | Inventive example |
| 8 | 200 | 5 | 5 | None | 0.5 | 0.02 | Inventive example |
| 9 | 200 | 10 | 5 | None | 0.3 | <0.01 | Inventive example |
| 10 | 200 | 50 | 5 | None | 0.2 | 0.02 | Inventive example |
| 11 | 50 | 0.5 | 5 | None | 0.3 | 0.02 | Inventive example |
| 12 | 50 | 1.0 | 5 | None | 0.1 | <0.01 | Inventive example |
| 13 | 50 | 5 | 5 | None | 0.1 | <0.01 | Inventive example |
| 14 | 50 | 10 | 5 | None | 0.2 | <0.01 | Inventive example |
| 15 | 50 | 50 | 5 | None | 0.5 | 0.01 | Inventive example |
| 16 | 50 | 10 | 10 | None | <0.1 | <0.01 | Inventive example |
| 17 | 50 | 10 | 2 | None | 0.1 | <0.01 | Inventive example |
| 18 | 50 | 10 | 1.0 | None | 0.2 | 0.02 | Inventive example |
| 19 | 20 | 10 | 20 | None | <0.1 | <0.01 | Inventive example |
| 20 | 20 | 10 | 5 | None | <0.1 | <0.01 | Inventive example |
| 21 | 300 | 10 | 5 | None | 0.8 | 0.02 | Inventive example |
| 22 | 50 | 10 | 5 | 0.1 | <0.1 | <0.01 | Inventive example |
| 23 | 50 | 10 | 5 | 3 | <0.1 | <0.01 | Inventive example |
| 24 | 50 | 10 | 5 | 5 | <0.1 | <0.01 | Inventive example |
| 25 | 50 | 5 | 1.0 | 5 | <0.1 | 0.01 | Inventive example |
| 26 | 50 | 5 | 0.8 | 5 | <0.1 | 0.01 | Inventive example |
| 27 | 400 | 1.0 | 5 | None | 15 | 4 | Comparative example |
| 28 | 100 | 0.4 | 5 | None | 160 | 3 | Comparative example |
| 29 | 100 | 60 | 5 | None | 3 | 0.5 | Comparative example |
| 30 | 400 | 60 | 5 | None | 40 | 0.8 | Comparative example |
| 31 | 100 | 60 | 5 | 5 | 2 | 1.0 | Comparative example |

### REFERENCE SIGNS LIST

1 nozzle (shielding-gas blowing nozzle)
1A gas outlet
2 gas tube,
3 gas flow rate controller
5 shielding gas
6 air entrainment
10 open pipe
11 portion to be welded (butting edge of open pipe)
12 heating starting point at edge of open pipe
13 welding point
15 electric resistance welded steel pipe or tube
20 feed direction (welding direction)
H nozzle height
R width
W maximum distance between end surfaces of portions to be welded

1. An open-pipe weld shielding system, the shielding system being configured for use in the manufacture of an electric resistance welded steel pipe or tube to shield portions to be welded with a shielding gas by blowing the shielding gas from above the portions to be welded during electric resistance welding,
the shielding system comprising:
a shielding-gas blowing nozzle that includes a gas outlet disposed at a position 5 to 300 mm above upper ends of the portions to be welded; and
a gas flow rate controller that is configured to control the flow rate of the shielding gas, which is blown from the gas outlet, in the range of 0.5 to 50 m/sec.

2. The open-pipe weld shielding system according to claim 1, wherein the gas outlet (i) is rectangular, (ii) has a length of 30 mm or more in a feed direction of the steel pipe or tube, and (iii) has a width R of 5 mm or more in a butt welding direction of the steel pipe or tube.

3. The open-pipe weld shielding system according to claim 1, wherein the gas outlet satisfies the relationship R/W>1.0, wherein R is the width of the gas outlet in a butt welding direction of the steel pipe or tube and W is the maximum distance between end surfaces of the portions to be welded immediately below the gas outlet.

4. The weld shielding system according to claim 3, wherein the gas outlet satisfies the relationship 1.5<R/W<25.

5. The weld shielding system according to claim 1, wherein the shielding-gas blowing nozzle is in a position and the flow rate of the shielding gas is in a range such that an oxygen concentration around the portions to be welded is 0.8%×10⁻² by volume or less.

6. A method of operating the weld shielding system of claim 1, the method comprising using an inert gas as the shielding gas during an electric resistance welding operation.

7. A method of operating the weld shielding system of claim 1, the method comprising using a gas containing 0.1% by volume or more reducing gas as the shielding gas during an electric resistance welding operation.

8. A method of operating the weld shielding system of claim 3, the method comprising using an inert gas as the shielding gas during an electric resistance welding operation.

9. A method of operating the weld shielding system of claim 3, the method comprising using a gas containing 0.1% by volume or more reducing gas as the shielding gas during an electric resistance welding operation.

10. A method of operating the weld shielding system of claim 1, the method comprising using a mixture of an inert gas and a gas containing 0.1% by volume or more reducing gas as the shielding gas during an electric resistance welding operation.

11. The method of claim 10, wherein the mixture is a mixture of nitrogen gas and hydrogen gas.
